(19) United States
(12) Patent Application Publication
(10) Pub. No.: US 2011/0254737 A1
(43) Pub. Date: Oct. 20, 2011

(54) SLOTTED ANTENNA DEVICE

(75) Inventors: Chieh-Ping Chiu, Tao Yuan Shien (TW); Feng-Jen Weng, Tao Yuan Shien (TW); Hsiao-Wei Wu, Tao Yuan Shien (TW); I-Ping Yen, Tao Yuan Shien (TW)

(73) Assignee: QUANTA COMPUTER INC.

(21) Appl. No.: 12/848,347

(22) Filed: Aug. 2, 2010

(30) Foreign Application Priority Data
Apr. 20, 2010 (TW) 099112350

(51) Int. Cl. H01Q 1/38

(52) U.S. Cl. 343/700 MS

(57) ABSTRACT

An antenna device includes a substrate and an antenna disposed on the substrate. The substrate has opposite first and second surfaces. The antenna is disposed on the first surface, and includes a feed-in portion, a radiator portion, and a grounding portion. The feed-in portion has a feed-in section for feeding of signals, and a connecting section opposite to the feed-in section. The radiator portion is connected to the connecting section and extends along a first longitudinal line. The grounding portion includes a first grounding section extending along a second longitudinal line from the feed-in section and spaced apart from the radiator portion. The substrate has a region that is between the first and second longitudinal lines and that is formed with a slot extending through the first and second surfaces.

### CROSS-REFERENCE TO RELATED APPLICATION

This application claims priority of Taiwanese Application No. 099112350, filed on Apr. 20, 2010.

### BACKGROUND OF THE INVENTION

1. Field of the Invention

The present invention relates to an antenna device, more particularly to a slotted antenna device.

2. Description of the Related Art

Generally, portable electronic devices (e.g., portable computers) have antenna devices operable in multiple frequency bands, such as the Wireless Local Area Network (WLAN) frequency bands and the Worldwide Interoperability for Microwave Access (WIMAX) frequency bands. Shown in FIG. 1 is a conventional Planar Inverted-F Antenna (PIFA) 91 that is installed in a monitor 92 of a portable electronic device.

However, as electronic devices nowadays are made with smaller dimensions, the amount of space in the monitor 92 for installation of the PIFA antenna 91 also decreases, which increases interference between the PIFA antenna 91 and other electronic components in the monitor 92. As a result, the radiation efficiency of the PIFA antenna 91 is compromised.

Therefore, how to improve the PIFA antenna 91 in terms of radiation efficiency without changing its dimensions is the subject of improvement of the present invention.

### SUMMARY OF THE INVENTION

Therefore, an object of the present invention is to provide a slotted antenna device having good radiation efficiency.

Accordingly, an antenna device of the present invention includes a substrate and an antenna disposed on the substrate. The substrate has opposite first and second surfaces. The antenna is disposed on the first surface, and includes a feed-in portion, a radiator portion, and a grounding portion.

The feed-in portion has a feed-in section for feeding of signals, and a connecting section opposite to the feed-in section. The radiator portion is connected to the connecting section and extends along a first longitudinal line. The grounding portion includes a first grounding section extending along a second longitudinal line from the feed-in section and spaced apart from the radiator portion.

The substrate has a region that is between the first and second longitudinal lines and that is formed with a first slot extending through the first and second surfaces.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic diagram illustrating a conventional Planar Inverted-F Antenna (PIFA);

FIG. 2 is a schematic diagram illustrating the first preferred embodiment of an antenna device according to the present invention;

FIG. 3 is a Voltage Standing Wave Ratio (VSWR) plot showing VSWR values of the antenna device at frequencies ranging from 2000 MHz to 6000 MHz;

FIGS. 4 to 6 are radiation pattern diagrams of the antenna device operating at 2442 MHz, 2600 MHz, and 5470 MHz, respectively, the radiation patterns of the antenna device at each of the frequencies being viewed on the X-Y, X-Z, and Y-Z planes; and

FIGS. 7 to 9 are schematic diagrams illustrating the second, third, and fourth preferred embodiments of an antenna device according to the present invention, respectively.

### DETAILED DESCRIPTION OF THE PREFERRED EMBODIMENTS

Before the present invention is described in greater detail, it should be noted that like elements are denoted by the same reference numerals throughout the disclosure.

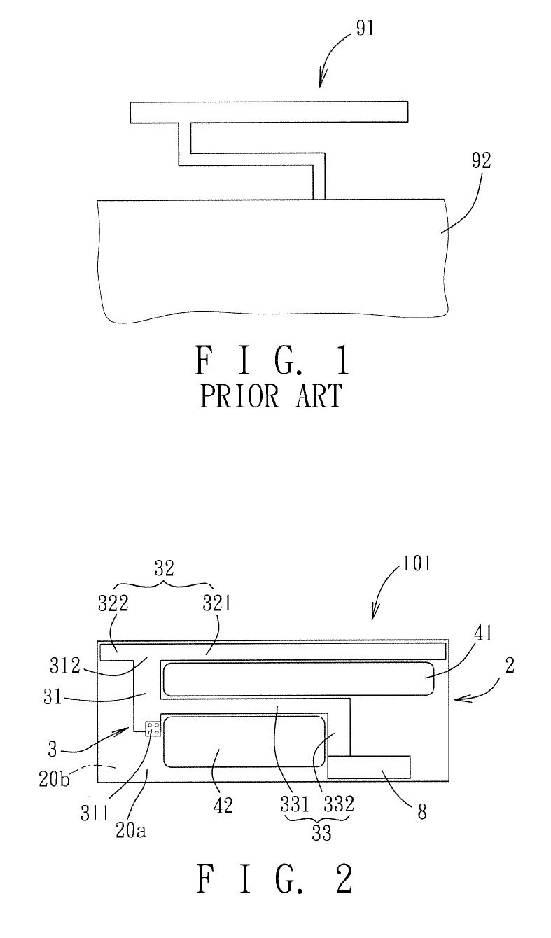

Referring to FIG. 2, the first preferred embodiment of an antenna device 101 according to the present invention is a Planar Inverted-F Antenna (PIFA) suitable for disposing in an electronic device (e.g., a portable computer), and includes a substrate 2 and an antenna 3.

The substrate 2 is rectangular, has a first surface 20a on which the antenna 3 is disposed, is a Printed Circuit Board (PCB) in this embodiment, and has dimensions of 25 mm×9 mm×0.6 mm (length×width×thickness). The substrate 2 further has a second surface 20b opposite to the first surface 20a.

The antenna 3 includes a feed-in portion 31, a radiator portion 32, and a grounding portion 33.

The feed-in portion 31 has a feed-in section 311 for feeding of signals, and a connecting section 312 opposite to the feed-in section 311.

The radiator portion 32 includes co-linear first and second radiator sections 321, 322 connected electrically to the connecting section 312, disposed at opposite sides of the connecting section 312, extending along a first longitudinal line, and resonant in first and second frequency bands, respectively.

The grounding portion 33 includes a first grounding section 331 extending along a second longitudinal line from the feed-in section 31 and spaced apart from the radiator portion 32. The first radiator section 321 and the first grounding section 331 are disposed on a same side of the feed-in portion 31, and have respective distal ends distal from the feed-in portion 31. The distal end of the first radiator section 321 extends along the first longitudinal line beyond the distal end of the first grounding section 331. The grounding portion 33 further includes a second grounding section 332 extending from the distal end of the first grounding section 331 in a direction away from the radiator portion 32, extending perpendicular to the first grounding section 331, and to be connected electrically to a copper foil 8 of the electronic device for grounding. It is to be noted that, in the present embodiment, the first and second longitudinal lines are perpendicular to the feed-in portion 31 and are parallel to each other.

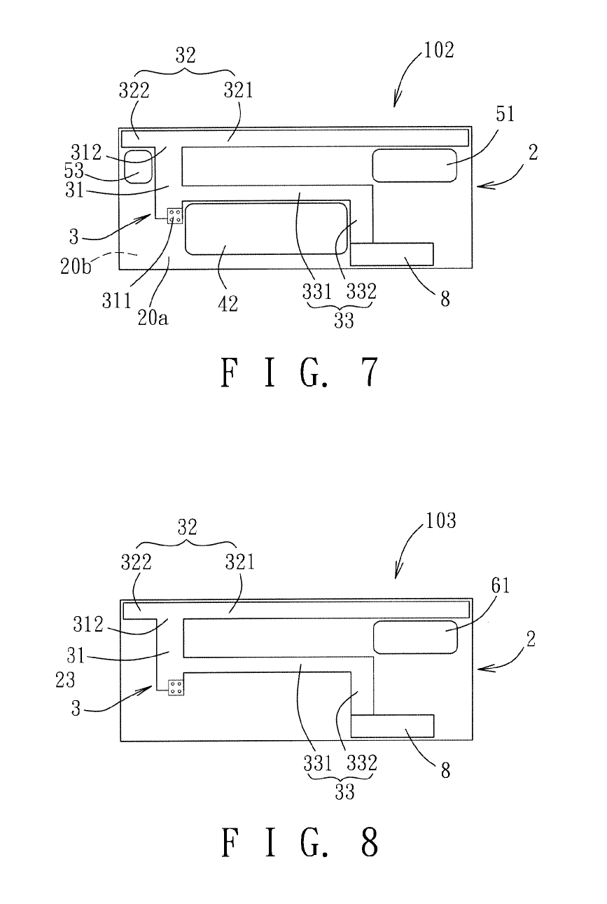

Moreover, the substrate 2 has a region located between the first and second longitudinal lines, and formed with a first slot 41 that is substantially rectangular, that extends through the first and second surfaces 20a, 20b, and that extends between the feed-in portion 31 and the distal end of the first radiator section 321. However, configuration of the first slot 41 is not limited to such. In other embodiments, the first slot 41 may be configured to extend between the distal ends of the first radiator section 321 and the first grounding section 331, as best shown in FIG. 7.

The first grounding section 331 has opposite first and second sides, the first slot 41 being adjacent to the first side. The substrate 2 is further formed with a second slot 42 that is substantially rectangular, that extends through the first and second surfaces 20a, 20b, that is surrounded at two sides by the first and second grounding sections 331, 332, and that is adjacent to the second side such that the first grounding section 331 is disposed between the first and second slots 41, 42.

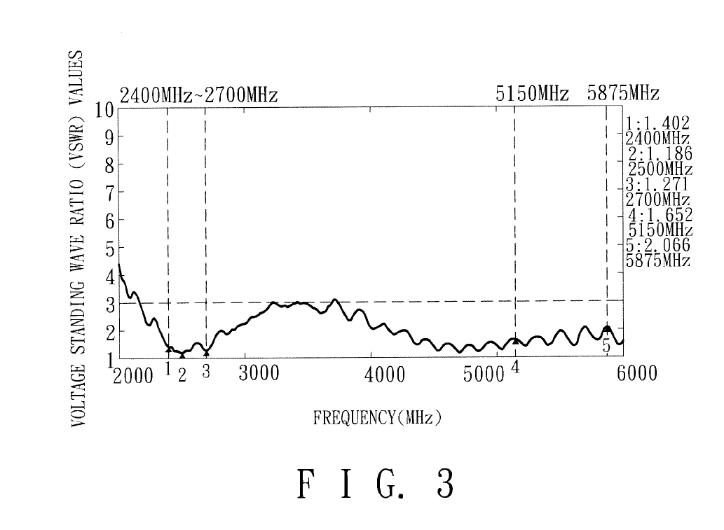

In the present embodiment, the first frequency band includes frequencies of the 2.4 GHz Wireless Local Area Network (WLAN) frequency band, and of the 2.5 GHz Worldwide Interoperability for Microwave Access (WIMAX) frequency band. The second frequency band includes frequencies of the 5 GHz WLAN frequency band. Referring to FIG. 3, the Voltage Standing Wave Ratio (VSWR) plot of the antenna device 101 shows that the antenna device 101 has VSWR values lower than 2 at frequencies ranging from 2.4 GHz to 2.7 GHz, and at frequencies ranging from 5.15 GHz to 5.875 GHz. Therefore, the antenna device 101 is operable in the WLAN and WIMAX frequency bands. It is to be noted that lengths of the first and second radiator sections 321, 322 can be adjusted for adjusting frequencies at which the antenna device 101 is operable.

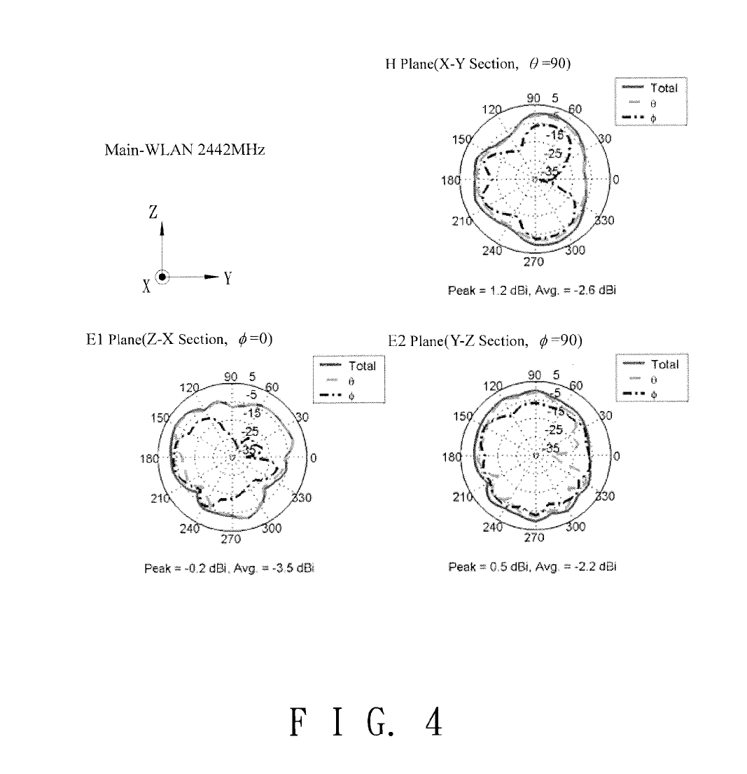

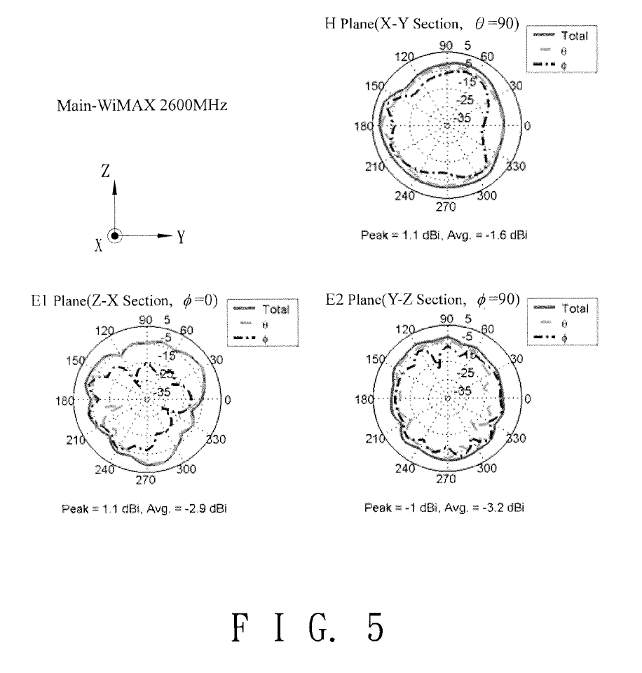

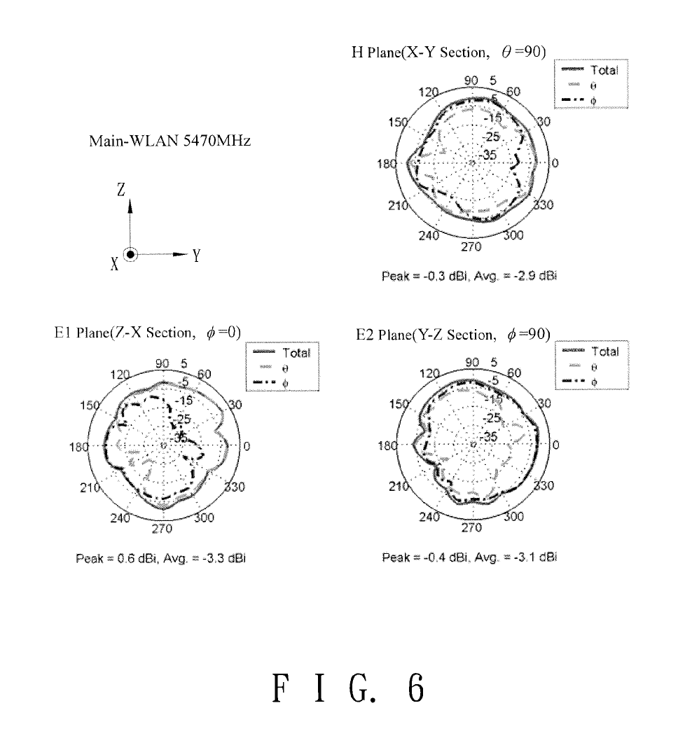

Furthermore, FIGS. 4 to 6 show radiation patterns of the antenna device 101 at frequencies of 2442 MHz, 2600 MHz, and 5470 MHz, respectively. Electrical fields and magnetic fields of the radiation patterns are presented on the X-Y, Z-X, and Y-Z planes. In each of the plane diagrams of the radiation patterns, the lighter dashed-line represents the electric field (theta), the darker dashed-line represents the magnetic field (phi), and the solid line represents the total of the electrical field and magnetic field. It can be noted from FIGS. 4 to 6 that radiation patterns of the antenna device 101 are substantially omni-directional. Shown in Table 1 are gain values of the antenna device 101 at different frequencies ranging from 2400 MHz to 5875 MHz, where gain is measured in decibel isotropic (dBi).

TABLE 1

| Frequency band | Frequency (MHz) | Gain (dBi) |
|---|---|---|
| WLAN (2.4 GHz) | 2400 | −2.8 |
| | 2442 | −2.7 |
| | 2484 | −2.3 |
| WIMAX (2.5 GHz) | 2500 | −2.5 |
| | 2525 | −2.7 |
| | 2550 | −2.7 |
| | 2575 | −2.7 |
| | 2600 | −2.5 |
| | 2625 | −2.5 |
| | 2650 | −2.4 |
| | 2675 | −2.6 |
| | 2700 | −2.3 |
| WLAN (5 GHz) | 5150 | −2.8 |
| | 5350 | −2.6 |
| | 5470 | −3.3 |
| | 5725 | −4.0 |
| | 5875 | −3.6 |

Referring to FIG. 7, the second preferred embodiment of an antenna device 102 according to the present invention is similar to the antenna device 101 of the first preferred embodiment. However, in the second preferred embodiment, the substrate 2 is formed with a first slot 51 extending between the distal ends of the first radiator section 321 and the first grounding section 331. Furthermore, the substrate 2 is further formed with a third slot 53 that is substantially rectangular, that extends through the first and second surfaces 20a, 20b, and that is surrounded at two sides by the second radiator section 322 and the feed-in portion 31 such that the feed-in portion 31 is disposed between the first and third slots 51, 53.

Referring to FIG. 8, the third preferred embodiment of an antenna device 103 according to the present invention differs from the antenna device 102 of the second preferred embodiment in that the substrate 2 of the antenna device 103 is formed only with the first slot 61.

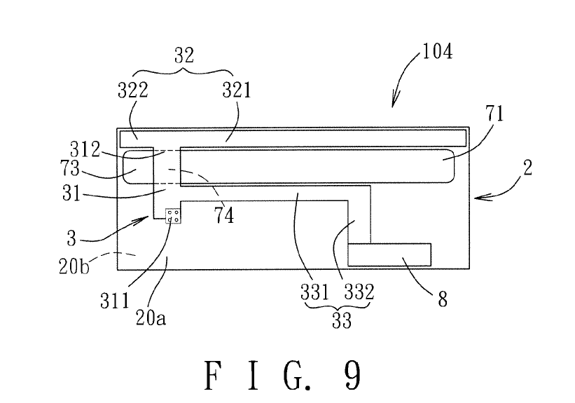

Referring to FIG. 9, the substrate 2 of the fourth preferred embodiment of an antenna device 104 according to the present invention is formed with a first slot 71 similar to the first slot 41 in the first preferred embodiment, with a third slot 73 similar to the third slot 53 in the second preferred embodiment, and with a fourth slot 74 that extends through the first and second surfaces 20a, 20b, that is located between the first and third slots 71, 73, and that spatially communicates the first and third slots 71, 73 such that the feed-in portion 31 extends across the fourth slot 74.

In summary, by virtue of forming the substrate 2 with different combinations of slots, efficiency of the antenna devices 101, 102, 103, 104 can be improved without changing the dimensions of the antenna devices 101, 102, 103, 104.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An antenna device comprising:
a substrate having opposite first and second surfaces; and
an antenna disposed on said first surface, including:
a feed-in portion having a feed-in section for feeding of signals, and a connecting section opposite to said feed-in section,
a radiator portion connected to said connecting section and extending along a first longitudinal line, and
a grounding portion including a first grounding section extending along a second longitudinal line from said feed-in section and spaced apart from said radiator portion;
wherein said substrate has a region that is between the first and second longitudinal lines and that is formed with a first slot extending through said first and second surfaces.

2. The antenna device as claimed in claim 1, wherein said radiator portion includes a first radiator section and a second radiator section that are connected to said connecting section.

3. The antenna device as claimed in claim 2, wherein said first radiator section and said second radiator section are disposed at opposite sides of said connecting section.

4. The antenna device as claimed in claim 3, wherein said first radiator section and said second radiator section are co-linear.

5. The antenna device as claimed in claim 4, wherein said first and second radiator sections are for transmitting and receiving wireless signals in first and second frequency bands, respectively.

6. The antenna device as claimed in claim 2, wherein said first radiator section and said first grounding section are disposed on a same side of said feed-in portion, each of said first radiator section and said first grounding section having a distal end distal from said feed-in portion, said distal end of said first radiator section extending along the first longitudinal line beyond said distal end of said first grounding section.

7. The antenna device as claimed in claim 6, wherein the first and second longitudinal lines are parallel to each other.

8. The antenna device as claimed in claim 7, wherein said first slot is substantially rectangular.

9. The antenna device as claimed in claim 6, wherein said first slot extends between said feed-in portion and said distal end of said first radiator section.

10. The antenna device as claimed in claim 6, wherein said first slot extends between said distal ends of said first radiator section and said first grounding section.

11. The antenna device as claimed in claim 1, wherein said first grounding section has opposite first and second sides, said first slot being adjacent to said first side, said substrate being further formed with a second slot that is adjacent to said second side such that said first grounding section is disposed between said first and second slots, said second slot extending through said first and second surfaces.

12. The antenna device as claimed in claim 1, wherein said grounding portion further includes a second grounding section that extends from one segment of said first grounding section distal from said feed-in portion and that extends away from said radiator portion, said substrate being further formed with a second slot that extends through said first and second surfaces and that is surrounded at two sides by said first and second grounding sections.

13. The antenna device as claimed in claim 12, wherein said second slot is substantially rectangular.

14. The antenna device as claimed in claim 12, wherein said radiator portion includes a first radiator section and a second radiator section that are connected to said connecting section, said first radiator section and said second radiator section being disposed at opposite sides of said connecting section, said substrate being further formed with a third slot that is surrounded at two sides by said second radiator section and said feed-in portion and that extends through said first and second surfaces.

15. The antenna device as claimed in claim 14, wherein said feed-in portion is disposed between said first and third slots.

16. The antenna device as claimed in claim 14, wherein said third slot is substantially rectangular.

17. The antenna device as claimed in claim 3, wherein said substrate is further formed with a third slot that is surrounded at two sides by said second radiator section and said feed-in portion and that extends through said first and second surfaces.

18. The antenna device as claimed in claim 17, wherein said feed-in portion is disposed between said first and third slots.

19. The antenna device as claimed in claim 17, wherein said third slot is substantially rectangular.

20. The antenna device as claimed in claim 17, wherein said substrate is further formed with a fourth slot that extends through said first and second surfaces, that is located between said first and third slots, and that spatially communicates said first and third slots, said feed-in portion extending across said fourth slot.
